(19) United States
(12) Patent Application Publication
(10) Pub. No.: US 2010/0148524 A1
(43) Pub. Date: Jun. 17, 2010

(54) Adjustable trim ring for deadbolt locks

(76) Inventors: Jerome F. Czerwinski, JR., Long Beach, CA (US); Marcus Clinton Meyer, Mission Viejo, CA (US)

Correspondence Address: Richard J. Veltman, Esq.;The Black & Decker Corporation, TW199, 701 East Joppa Road, Towson, MD, 21286, US

(21) Appl. No.: 12/316,399

(22) Filed: Dec. 12, 2008

(51) Int. Cl. E05C 19/00

(52) U.S. Cl. 292/299

(57) ABSTRACT

An extendable trim ring for deadbolt locks having a collar slidably mounted in an annular flange. The flange is defined by a tubular wall outwardly-encircled by a protruding lip, and a notch running around the lip. In addition, the rim of the flange is defined by alternately longer and shorter teeth. The annular collar is slidably received within the annular flange. Specifically, the annular collar has a tubular wall seated within the notch of the flange. The inner surface of the collar is defined by a plurality of recessed axial tracks for slidably receiving the alternately longer and shorter teeth of the flange. Thus, the collar can be pulled from the flange (to extract said teeth from the tracks), rotated, and reinserted for pull-and-twist adjustment of the extension of the collar from the flange. The convenient pull-and-twist adjustment accommodates two different door thicknesses, such as a standard 1⅜″ [35 mm] to a narrow door thickness of or 1¾″ [44 mm], or as otherwise desired for residential door thicknesses, and can easily set and installed in the field.

### BACKGROUND OF THE INVENTION

1. Field of the Invention

The present invention relates to deadbolt locks, and more particularly to an adjustable trim ring for a deadbolt lock with convenient pull-and-twist adjustment to accommodate two different door thicknesses such as 1⅜″ [35 mm] or 1¾″ [44 mm], or as needed for residential door thicknesses.

2. Description of the Background

In most typical deadbolt locks, a lock cylinder actuates a bolt mechanism which extends a bolt into/out from a strike plate on a door frame. The lock cylinder may be operable either by a thumb-knob or keyway, in both cases the axis of rotation of the lock cylinder engaging the bolt mechanism orthogonally. Under motion of the lock cylinder the bolt is selectively engaged and disengaged from a strike plate mounted to the door frame. Typical lock cylinders for deadbolt door locks are enclosed within cylinder covers, and an exterior faceplate (or “keyway rosette”) is inserted over the lock cylinder to seat flush against the door. However, this configuration is intended for a singular door thickness and cannot be adapted to doors of substantially different thicknesses, such as from the standard 1⅜″ [35 mm] to a narrow door thickness of or 1¾″ [44 mm]. This presents significant installation problems in the field, where difficulties are encountered when fitting and mounting surface-mounted deadbolt locks.

FIG. 1 illustrates a conventional deadbolt lock configuration for a standard door. The lock cylinder 12 actuates a bolt mechanism 14 that extends a bolt 16 out through a deadbolt plate 18 mounted edgewise to the door, and across to the door frame hardware such as an adjacent strike plate 19 (shown in dotted lines) mounted on the opposing doorjamb. The lock cylinder 12 here operates by a keyway for engaging the bolt mechanism 14. The lock cylinder 12 is housed inside an annular cylinder cover 20 that extends back and around the lock cylinder 12 for protection thereof. Finally, a trim ring 22 is inserted over the cylinder cover 20 and seats flush with the surface of the door. However, when a thin door condition is encountered, the lock cylinder 12 effectively protrudes further from the door surface, and the cylinder cover 20 and trim ring 22 must bridge the gap. The industry standard solution is essentially to break the trim ring 22 into two discrete telescoping parts.

For example, FIG. 2 shows one variation of a trim ring 24 inserted beneath an annular collar 23 to provide a few centimeters extension. FIG. 3 shows another variation of a trim ring 24 inserted above the annular collar 23 to provide the same few centimeters extension. These solutions are cumbersome because they require an inventory of parts and are not aesthetically pleasing.

Other prior efforts exist to make deadbolt locksets adaptable to varying door thicknesses, but these use fairly complex mechanisms. For example, U.S. Pat. No. 4,573,334 by Crepinsek issued Mar. 4, 1986 shows a deadbolt lock adjustable for mounting in doors of various thicknesses. The keyway rosette 43 is provided with an inward protruding externally threaded cylindrical extension 45, and an internally threaded cylinder 46 is non-adjustably mounted to and within lock body 10 to couple externally threaded cylindrical extension 45 of rosette 43. The threaded extension 45 allows adjustment of the keyway rosette 43 inward or out, to suit the door thickness.

U.S. Pat. No. 5,683,127 to Chamberlain issued Nov. 4, 1997 shows a removable faceplate that allows greater flexibility since the style of faceplate can be changed in the field to accommodate various installation requirements. An interlocking front faceplate and a collar captures a locking tab of the deadbolt housing permitting the rapid field assembly of a selected front face or trim plate by simply engaging intermeshing fingers by rotation of the collar to secure the assembly, which thereafter may be driven into an aperture prepared for a door lock.

U.S. Pat. No. 4,708,007 to Stoia issued Nov. 24, 1987 shows a secure mounting system for a deadbolt lock adapted to accommodate a wide range of door thicknesses. The device includes a front section and a rear section which are passed through the front and rear ends of a hole formed through the door. The portions of the front and rear sections which meet within the door hole are threaded together to clamp the door between the front and rear sections. This threaded engagement of the front section and rear section allows some adjustability for varying door thicknesses.

U.S. Pat. No. 5,533,368 to Eagan issued Jul. 9, 1996 shows a means for, and a method of, adjusting a cylindrical lockset for door thickness-sizing. An adjustable spring-cage is spring-biased away from the lock chassis, and is retained on a projecting shaft by an adjusting nut. By moving the nut on the shaft, the cage is moved relative to the shaft and is selectively aligned with a chosen door thickness.

U.S. Pat. No. 3,815,390 to Stoia issued Jun. 11, 1974 shows a key-cylinder which is adjustable to accommodate a range of door thicknesses. The outside cover plate is threaded onto the key-cylinder for some degree of adjustment.

U.S. Pat. No. 6,131,970 to Hurst et al. issued Oct. 17, 2000 shows a latch assembly with keyed rose plate for adjustment to doors of differing thickness without the use of threaded components. The latch assembly includes a latch body with an outside end having at least two grooves. The grooves are preferably spaced longitudinally apart from one another by one-half (½) the difference in standard door thickness. An outside rose plate fits over the outside end of the latch body and may be engaged in any one of the grooves. By engaging the outside rosette plate in the appropriate groove for the door thickness and fixing the rose plates to one another and snug against the door, the latch body is maintained in the center of the door.

U.S. Pat. No. 6,302,457 to Shen issued Oct. 16, 2001 shows an easy-to-install door lock with an inside seat and an outside seat. An inside rose liner is mounted around the inside seat. An outside rose is securely mounted around the outside rose liner to rotate move therewith. Rotation of the outside rose causes longitudinal movement of the outside rose and the outside rose liner relative to the outside seat to suit different door thickness.

U.S. Pat. No. 6,619,710 to Hwang issued Sep. 16, 2003 shows an adjustable lock for various door thicknesses. The lock can be mounted to doors having various door thicknesses by means of simple turning of the gear 34 by a tool.

Even though the foregoing references improve adaptability so that the correct set of fittings can be selected at the installation site, the adjustability comes by axial adjustment of the keyway rosette on a threaded hub, or something similar. In this case the fit may still be imprecise, and difficulties in alignment and centering of the lock with respect to the door and the lock mount are common. As a result, installation can be quite difficult, frustrating and time consuming.

It would be greatly advantageous to provide an adjustment feature with a trim ring for deadbolt locks to allow adjustment while providing a uniform outward aesthetic, which avoids the foregoing difficulties. The present invention accomplishes the foregoing with a two-component trim ring that facilitates a simple pull-and-twist adjustment to accommodate different door thicknesses.

### SUMMARY OF THE INVENTION

The present invention is an extendable trim ring for deadbolt locks having an extendable collar mounted in an annular flange. The flange is defined by a tubular wall outwardly-encircled by a protruding lip, and a notch running around the lip. In addition, the rim of the flange is defined by alternately longer and shorter teeth which serve as spacers. The annular collar is slidably received within the annular flange. Specifically, the annular collar has a tubular wall seated within the notch of the flange. The inner surface of the collar is defined by a plurality of recessed axial tracks for slidably receiving the alternately longer and shorter teeth of the flange. Thus, the collar can be pulled from the flange (to extract said teeth from the tracks), rotated, and reinserted for pull-and-twist adjustment of the extension of the collar from the flange. The convenient pull-and-twist adjustment accommodates two different door thicknesses, such as a standard 1⅜″ [35 mm] to a narrow door thickness of or 1¾″ [44 mm], or as otherwise desired for residential door thicknesses, and can easily set and installed in the field.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 illustrates a conventional (prior art) deadbolt lock configuration for a standard door.

FIG. 2 shows one variation of a prior art trim ring inserted beneath an annular collar to provide a few centimeters extension.

FIG. 3 shows another variation of another prior art trim ring inserted above the annular collar to provide the same few centimeters extension.

FIG. 4 is a perspective view of the adjustable trim ring 2 for deadbolt locks according to one embodiment of the present invention, set in a high position.

FIG. 5 is a side view of the adjustable trim ring 2 as in FIG. 4.

FIG. 6 is a side cross-section of the adjustable trim ring 2 as in FIGS. 4-5.

FIGS. 7-9 are a perspective view, side view, and side cross-section of the adjustable trim ring 2 as in FIGS. 4-6 set in a low position.

FIGS. 10-11 are perspective views of an alternate square embodiment of the adjustable trim ring 200 similar to FIGS. 4-9 set in a high and low position, respectively.

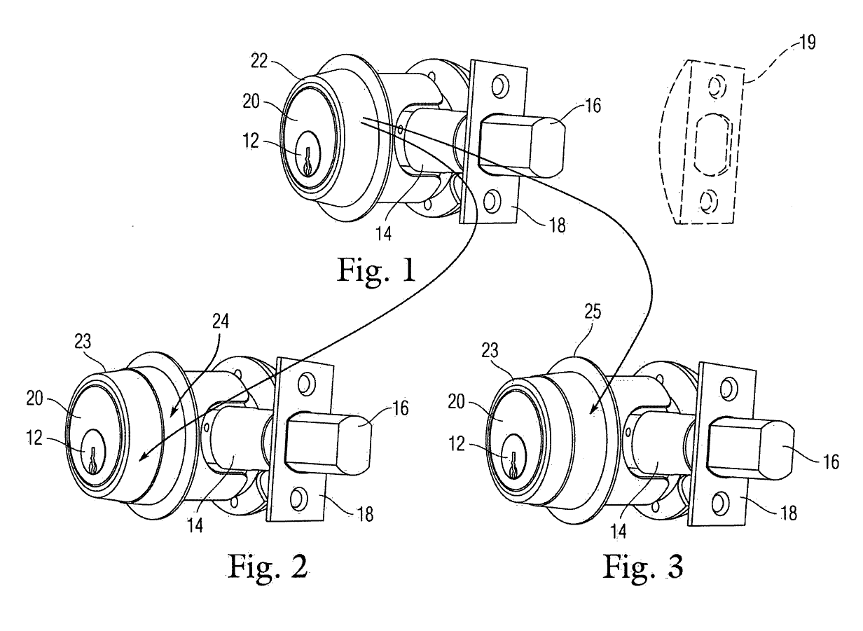

### DETAILED DESCRIPTION OF THE PREFERRED EMBODIMENTS

The present invention is an adjustable trim ring for deadbolt locks with convenient pull-and-twist adjustment to accommodate two different door thicknesses, such as a standard 1⅜″ [35 mm] to a narrow door thickness of or 1¾″ [44 mm], or as otherwise desired for residential door thicknesses. The adjustable trim ring can be easily set and installed in the field.

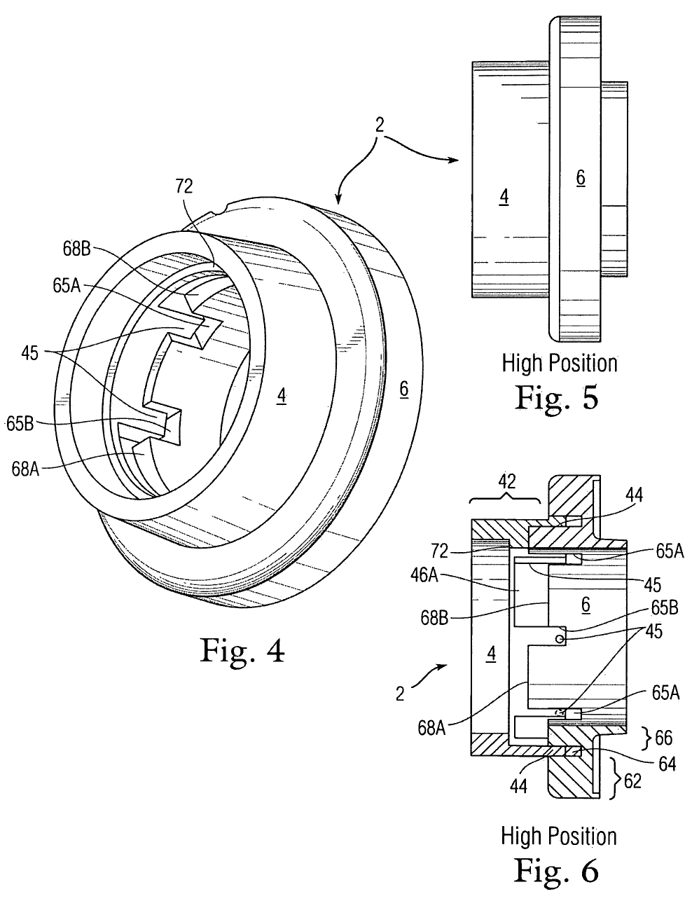

FIG. 4 is a perspective view of the adjustable trim ring 2 for deadbolt locks according to one embodiment of the invention, FIG. 5 is a side view, and FIG. 6 is a side cross-section. The adjustable deadbolt backset latch 2 generally comprises an outer annular collar 4 slidably seated in an inner annular flange 6. As seen in FIG. 6, the inner annular flange 6 is defined by a circular lip 62 integrally joined to an inner wall 66 across a narrow notch 64. The inner wall 66 is defined by a plurality of teeth 68A & 68B evenly spaced around the circle, each pair of teeth being separated by a notch 65A & 65B. The teeth serve as spacers, and include alternately longer teeth 68A and shorter teeth 68B, the longer teeth 68A being, for example, on the order of 6/8″ [18 mm] and the shorter teeth 68B being, for example, on the order of ⅜″ [9 mm]. The notches are also alternately longer notches 65A and shorter notches 65B, the longer notches 65A being approximately 9 mm deeper than the shorter notches 68B. In the present embodiment six (6) teeth 68A & 68B and six (6) notches 65A & 65B are alternately spaced around the inner wall 66. The annular collar 4 is defined by cooperating features. Specifically, annular collar 4 is defined by a circular wall 42 with an inner ridge 72 for seating the deadbolt keyslot. The inner surface of wall 42 is defined by a plurality of recessed tracks 46A & 46B evenly spaced around the circle, the recessed tracks 46A & 46B defining a thin outer wall 44, and each being separated from the next by axial ribs 45. The annular collar 4 fits slidably into the inner annular flange 6 with the teeth 68A & 68B of flange 6 fitting into the recessed tracks 46A & 46B of collar 4, and the ribs 45 of collar 4 fitting into the notches 65A & 65B of flange 6. Owing to the alternately longer/shorter notches 65A & 65B, and the alternately longer/shorter teeth 68A, 68B, the adjustable trim ring 2 is adjusted simply by extracting the collar 2 and rotating 62 degrees from a first extension to a second extension 9 mm offset from the first extension. Thus collar 4 is adjustable by convenient pull-and-twist adjustment relative to the flange 6 to facilitate easy installation at either a standard 1⅜″ [35 mm] to a narrow door thickness of or 1¾″ [44 mm], or as otherwise desired for residential door.

FIGS. 4-6 illustrate the adjustable trim ring 2 set in a high position for a narrow door thickness of 1¾″ [44 mm].

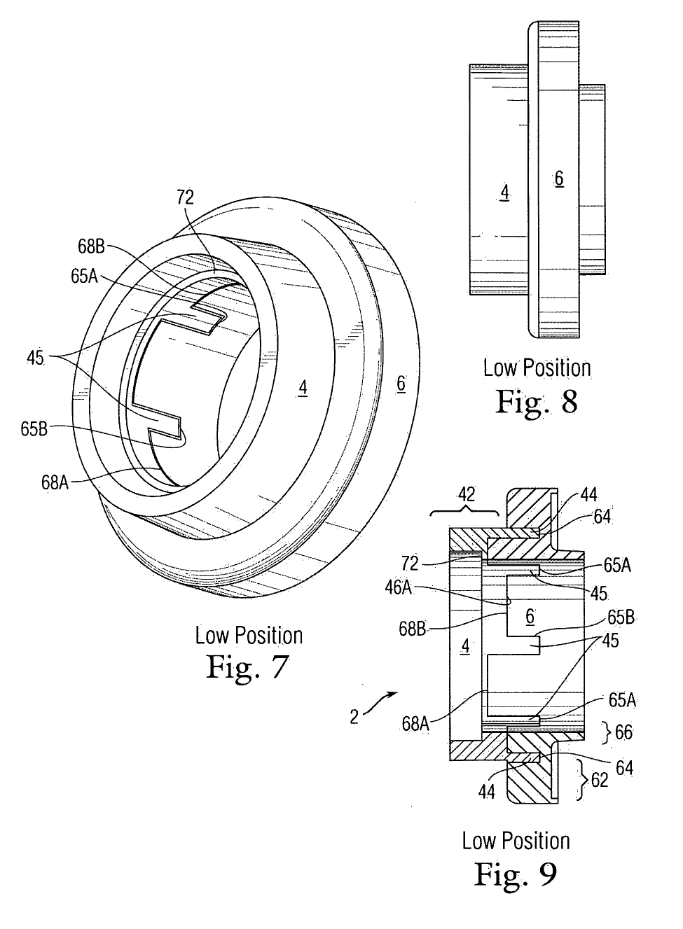

FIGS. 7-9 are a perspective view, side view, and side cross-section of the adjustable trim ring 2 for deadbolt locks as in FIGS. 4-6 but set in a low position for a standard 1⅜″ [35 mm] door thickness. Note that the way that the annular collar 4 fits slidably into the inner annular flange 6 presents a clean and uniform outward aesthetic, with the thinner section 44 of the wall 42 of collar 4 sliding flush inside the narrow notch 64 of annular flange 6 to present a unitary appearance. It should now be apparent that the present invention provides an improved trim ring for deadbolt locks with convenient pull-and-twist adjustment to accommodate two different door thicknesses, such as a standard 1⅜″ [35 mm] to a narrow door thickness of or 1¾″ [44 mm], or as otherwise desired for residential door thicknesses.

Moreover, the configuration of the device lends itself to a variety of shapes and sizes all relying on the same alternately longer/shorter notches and the alternately longer/shorter teeth for pull and twist extension.

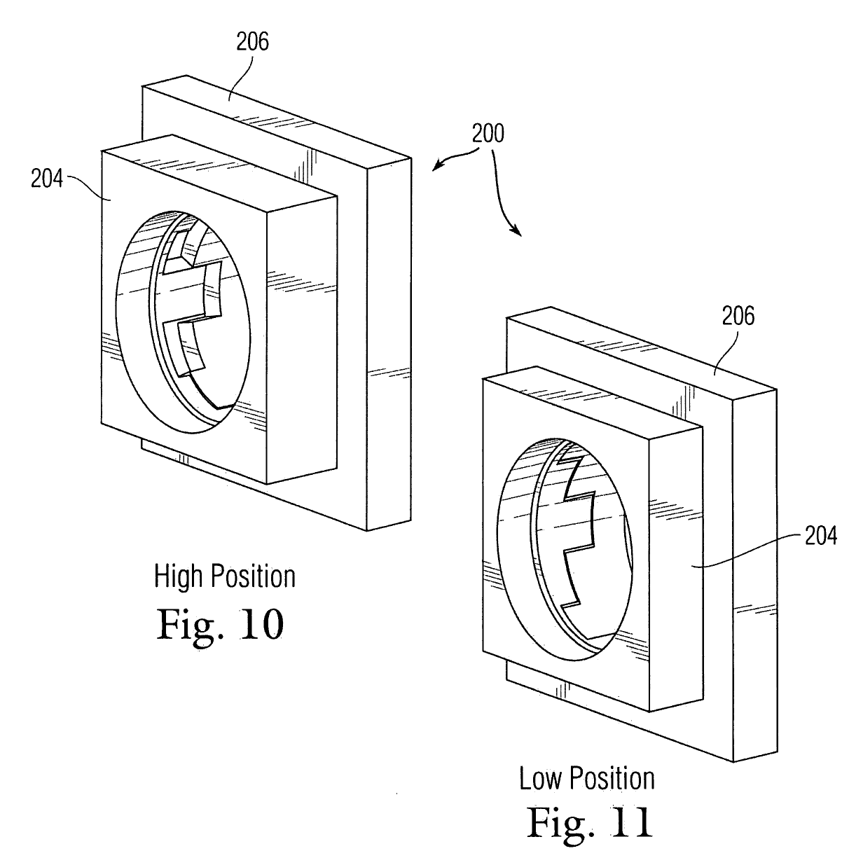

FIGS. 10-11 are perspective views of an alternate square embodiment of the adjustable trim ring 200 similar to FIGS. 4-9 set in a high and low position, respectively. The square outer collar 204 is slidably seated in a square inner flange 206. The square inner flange 206 is inwardly defined by the same complement of notches and teeth, and the square outer collar 204 with the same cooperating features as described above with regard to FIGS. 4-9. Again, the square outer collar 204 fits slidably into the square inner flange 206 with the teeth of flange 206 fitting into the recessed tracks of collar 204, and the ribs of collar 204 fitting into the notches of flange 206. Thus collar 204 is adjustable by convenient pull-and-twist adjustment relative to the flange 206 to facilitate easy installation at either a standard 1⅜″ [35 mm] to a narrow door thickness of or 1¾″ [44 mm], or as otherwise desired for residential door.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

I claim:

1. An extendable trim ring for a door lock of a type including a keyway accessible from outside a door engaging a cylinder passing into said door, the extendable trim ring flush-mounting said keyway to said door and comprising:
a flange abutting said door and including a base defined by an annular protruding lip surrounding an aperture through said flange, and a recessed groove surrounding said lip, said lip being further defined by a plurality of alternating teeth spaced by a corresponding plurality of notches, said teeth being alternately longer and shorter; and
a collar slidably and rotatably received within said flange, said collar having an annular wall seated within the groove of said flange, and the annular wall having an inner surface defined by a plurality of recessed tracks for slidably receiving the alternately longer and shorter teeth of said flange;
whereby said collar may be pulled from said flange to withdraw said teeth from said tracks, rotated, and reinserted for pull-and-twist adjustment of an extension of said collar from said flange.

2. The extendable trim ring for a door lock according to claim 1, wherein the plurality of alternating teeth of said flange extend to an arcuate surface.

3. The extendable trim ring for a door lock according to claim 2, wherein the arcuate surface of at least one tooth is spaced further from said base than the arcuate surface of another tooth.

4. The extendable trim ring for a door lock according to claim 2, wherein the notches between the teeth of said flange are recessed to varying extents.

5. The extendable trim ring for a door lock according to claim 1, wherein the plurality of recessed tracks of said collar are recessed to varying extents.

6. The extendable trim ring for a door lock according to claim 1, wherein the base of said flange is circular.

7. The extendable trim ring for a door lock according to claim 1, wherein the base of said flange is square.

8. The extendable trim ring for a door lock according to claim 1, wherein the pull-and-twist adjustment accommodates two different door thicknesses.

9. The extendable trim ring for a door lock according to claim 8, wherein the wherein the pull-and-twist adjustment accommodates standard 1⅜″ [35 mm] and narrow 1¾″ [44 mm] door thicknesses.

10. An extendable trim ring for a door lock, comprising:
a flange abutting a door and including a base defined by an annular protruding lip, said lip being interrupted by a plurality of notches to define a corresponding plurality of protruding spacers of alternately longer and shorter extent; and
a collar slidably and rotatably received within said flange, said collar having an annular wall seated within said flange, and the annular wall being formed with an inner surface defined by a plurality of recesses tracks for slidably receiving the alternately longer and shorter spacers of said flange;
whereby said collar may be extracted from said flange to withdraw said spacers from said recesses, rotated, and reseated to adjust extension of said collar from said flange.

11. The extendable trim ring for a door lock according to claim 10, wherein the plurality of alternating spacers of said flange each have an arcuate bearing surface.

12. The extendable trim ring for a door lock according to claim 11, wherein the arcuate bearing surfaces of said spacers lie along two different planes.

13. The extendable trim ring for a door lock according to claim 12, wherein the recessed notches of said flange each have an arcuate bearing surface.

14. The extendable trim ring for a door lock according to claim 13, wherein the arcuate bearing surfaces of said notches lie along two different planes.

15. The extendable trim ring for a door lock according to claim 10, wherein the base of said flange is circular.

16. The extendable trim ring for a door lock according to claim 10, wherein the base of said flange is square.

17. The extendable trim ring for a door lock according to claim 10, wherein the said collar may be reseated in said flange to accommodate one of two different door thicknesses.

18. The extendable trim ring for a door lock according to claim 17, wherein the collar may be reseated in said flange to accommodate a standard 1⅜″ [35 mm] or narrow 1¾″ [44 mm] door thickness.

19. An extendable trim ring for a lock, comprising:
an annular flange defined by a tubular wall outwardly-encircled by a protruding lip defined by a notch, a rim of said tubular wall being defined by alternately longer and shorter teeth; and
an annular collar slidably received within said annular flange, said annular collar having a tubular wall seated within the notch of said flange, and the tubular wall having an inner surface defined by a plurality of recessed axial tracks for slidably receiving the alternately longer and shorter teeth of said flange;
whereby said collar may be pulled from said flange to extract said teeth from said tracks, rotated, and reinserted for pull-and-twist adjustment of an extension of said collar from said flange.
